(19) United States
(12) Patent Application Publication
(10) Pub. No.: US 2025/0224538 A1
(43) Pub. Date: Jul. 10, 2025

(54) METHOD AND SYSTEM FOR MINERAL PROSPECTIVITY MAPPING

(71) Applicant: SRI International, Menlo Park, CA (US)

(72) Inventors: Han-Pang CHIU, West Windsor, NJ (US); Angel Andres DARUNA, Davie, FL (US); Vasily ZADOROZHNYY, Hamilton Township, NJ (US)

(21) Appl. No.: 18/980,409

(22) Filed: Dec. 13, 2024

Related U.S. Application Data
(60) Provisional application No. 63/619,217, filed on Jan. 9, 2024.

(51) Int. Cl. G01V 20/00

(52) U.S. Cl. CPC G01V 20/00

(57) ABSTRACT

A method and system for generating mineral potential maps (MPM) is described in embodiments consistent with the present disclosure. In some embodiments, a method for generating an MPM includes extracting features from mineral mapping data (MMD) from a plurality of data source modalities using one or more feature extraction networks; fusing the features extracted by each of the one or more feature extraction networks to produce fused multimodal features; projecting the fused multimodal features into an embedding space that is trained to classify the features' mineral deposit potential; and generating mineral potential data indicating a spatial output of mineral deposit potential.

### CROSS-REFERENCE TO RELATED APPLICATION

This application claims priority to and the benefit of U.S. Provisional Patent Application Ser. No. 63/619,217, filed Jan. 9, 2024, which is incorporated herein by this reference in its entirety.

### GOVERNMENT RIGHTS STATEMENT

This invention was made with Government support under contract no. HR0011-23-9-0130 awarded by the Defense Advanced Research Projects Agency (DARPA). The Government has certain rights in this invention.

### FIELD

Embodiments of the present principles generally relate to methods, apparatuses, and systems for using Artificial Intelligence (AI) and Machine Learning (ML) for Mineral Prospectivity Mapping (MPM).

### BACKGROUND

Machine Learning (ML) for Mineral Prospectivity Mapping (MPM) remains a challenging problem as it requires the analysis of associations between large-scale multi-modal geospatial data and few historical mineral commodity observations (positive labels). Recent MPM works have explored Artificial Intelligence (AI) and Deep Learning (DL) as a modeling tool with more representation capacity. However, these over-parameterized methods may be more prone to overfitting due to their reliance on scarce labeled data.

Specifically, current AI-based MPM methods face two serious data label scarcity challenges naturally inherent in mineral-relevant data sources. First, these methods are generally based on supervised training, that requires a large number (e.g., thousands) of labeled samples to train an effective model. Each labeled sample includes a ground truth probability of whether a mineral deposit exists at a specific location, with all annotated input data modalities/sources.

Second, the input data to the model are required to be complete (without missing values), for ensuring reasonable prediction. These challenges are exacerbated when making greenfield predictions in underexplored environments, where sparse data labels and wholly incomplete input data are commonplace. In addition, these methods do not use expert knowledge to regularize or improve their models. The trained models easily overfit (model overfitting) on areas with labeled training samples, that cannot generalize well to new test areas with unlabeled data.

That is, while a large quantity of unlabeled geospatial data exists, no prior MPM works have considered using such information in a self-supervised manner. Furthermore, with voluminous increases in data availability, current USGS data fusion methods cannot seamlessly merge and stack heterogeneous (e.g., multi-resolution) data sources to output mineral deposit probabilities with reliable uncertainty estimates for the area of interest.

Thus, new effective and scalable solution are needed to process and fuse diverse multi-source data for probabilistic MPM.

### SUMMARY

A method and system for generating mineral potential maps (MPM) is described in embodiments consistent with the present disclosure. In some embodiments, a method for generating an MPM includes extracting features from mineral mapping data (MMD) from a plurality of data source modalities using one or more feature extraction networks; fusing the features extracted by each of the one or more feature extraction networks to produce fused multimodal features; projecting the fused multimodal features into an embedding space that is trained to classify the features' mineral deposit potential; and generating mineral deposit potential data indicating a spatial output of mineral deposit potential.

In some embodiments, a Mineral Prospectivity Mapping (MPM) system for generating mineral potential maps includes one or more feature extraction networks configured to extract features from mineral mapping data (MMD) obtained from a plurality of data source modalities; a multimodal autoencoder configured to fuse the features extracted by each of the one or more feature extraction networks to produce fused multimodal features; an embedding space configured to store the fused multimodal features projected into it, and trained to classify the features' mineral deposit potential; and a mineral potential data generation module configured to generate a mineral potential data indicating a spatial output of mineral deposit potential.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high level block diagram of a Mineral Prospectivity Mapping (MPM) system in accordance with an embodiment of the present principles.

FIG. 2 depicts the multi-dimensionality of the mineral mapping data in accordance with an embodiment of the present principles.

FIG. 3 depicts a feature extraction network using an encoder-decoder architecture in accordance with at least one embodiment of the present principles.

FIG. 4 depicts a feature extraction network using unimodal and multimodal masked autoencoders in accordance with at least another embodiment of the present principles.

FIG. 5 depicts an exemplary mineral potential map showing prospectivity/probability of a mineral as well as uncertainty/standard in accordance with embodiments of the present principles.

FIG. 6 depicts a feature importance map for an explanatory variable as a heatmap in accordance with an embodiment of the present principles.

FIG. 7 depicts a flow chart of a Mineral Prospectivity Mapping (MPM) method for generating mineral potential maps in accordance with an embodiment of the present principles.

FIG. 8 is a simplified block diagram of a computer system in accordance with an embodiment of the present principles.

FIG. 9 depicts a high level block diagram of a network in which embodiments of a Mineral Prospectivity Mapping (MPM) system in accordance with the present principles can be applied.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

This disclosure describes inventive concepts with reference to specific examples. However, the intent is to cover all modifications, equivalents, and alternatives of the inventive concepts that are consistent with this disclosure. It will be apparent, however, to one of ordinary skill in the art that the present approach can be practiced without these specific details. Thus, the specific details set forth are merely exemplary and are not intended to limit what is presently disclosed. The features implemented in one embodiment may be implemented in another embodiment where logically possible. The specific details can be varied from and still be contemplated to be within the spirit and scope of what is being disclosed.

Embodiments of the present principles relate to methods, apparatuses and systems for generating mineral potential data. Embodiments consistent with the inventive MPM methods and systems described herein can be used to build geospatial foundation models for mineral exploration which advantageously provide a self-supervised MPM pretraining method based on masked image modeling that leverages unlabeled geospatial data, incorporate explainable AI and epistemic uncertainty modeling into the DL MPM method to validate individual DL MPM predictions from a geological perspective, and treat MPM as an imbalanced, positive-unlabeled binary classification problem, leading to the formulation of a novel undersampling method for MPM.

More specifically, the novel unified framework described addresses prior DL difficulties for MPM, using self-supervised learning (SSL), explainable artificial intelligence, and epistemic uncertainty modeling. The inventive methods and systems described includes a single backbone model that is pretrained, then reused for various downstream MPM tasks (i.e., prediction of a mineral deposit type is a single task). Training a single backbone model that can be used across multiple tasks (multiple mineral deposit types) is made possible through a masked image modeling objective that exclusively uses unlabeled data. In this way, the learned features are a generic representation of the localized geospatial information that can be used for MPM. In addition to self-supervised learning, MPM is treated as an imbalanced, positive-unlabeled binary classification problem. This problem formulation leads to a novel undersampling technique, that reduces the chance of labeling unknown true positives as negative samples in previous works. Integrated gradients feature attribution method is also leveraged to offer insights into which explanatory features most influenced each MPM prediction. The method and systems described herein produces predictions that pair each presence likelihood with an epistemic uncertainty measure. The capabilities of the inventive MPM method and system described provides feature attributions and uncertainties that reduce the barriers to validate the DL MPM predictions from a geological perspective.

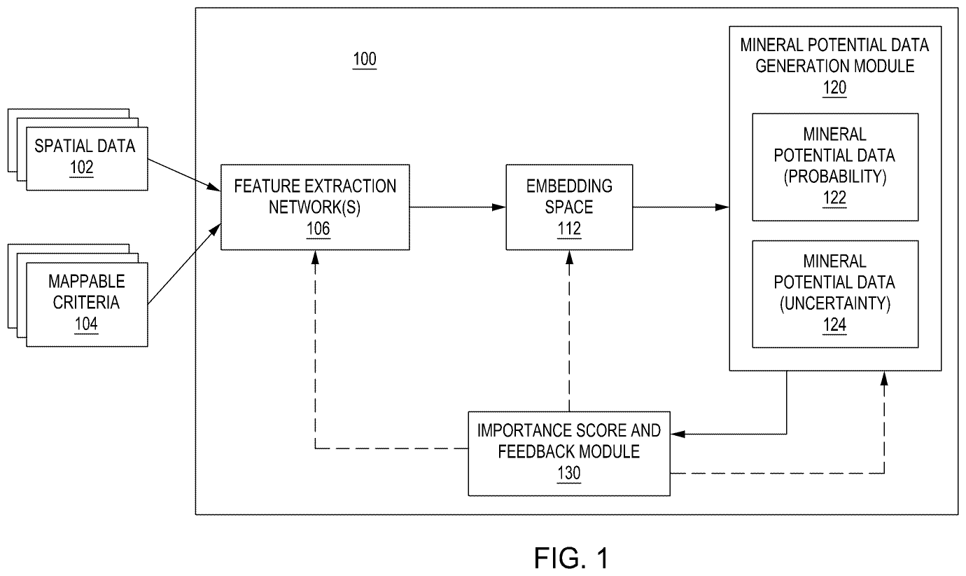

FIG. 1 depicts a high level block diagram of a Mineral Prospectivity Mapping (MPM) system 100 in accordance with an embodiment of the present principles. The MPM system 100 of FIG. 1 illustratively comprises one or more feature extraction networks 106, one or more embedding spaces 112, a mineral potential data module 120, and an importance score and feedback module 130, which are described below in further detail.

The one or more feature extraction networks 106 extract features from mineral mapping data (MMD) obtained from a plurality of data source modalities. In some embodiments, the one or more feature extraction networks 106 are used to both extract and fuse the features from the MMD.

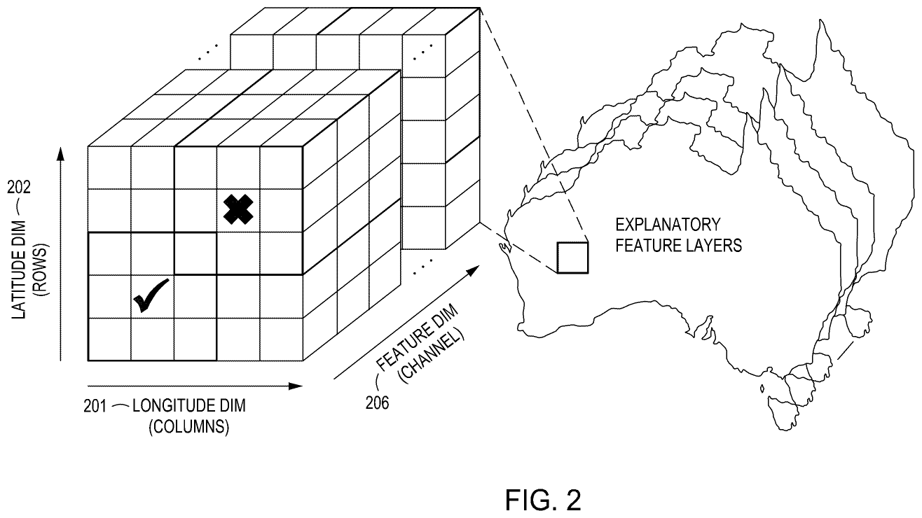

The plurality of data source modalities can include spatial data modalities 102 and mapping criteria data modalities 104. In some embodiments, the spatial data 102 includes one or more of geophysics data, geological maps, remote sensing data (e.g., including GPS or satellite imaging, or data from a plane, drone or other moving vehicle), and/or geochemistry data. In some embodiments, the mappable criteria data 104 includes one or more of a location of mineral deposit sites, grading models, or tonnage models. In some embodiments, the mineral mapping data includes labeled and/or unlabeled data. In some embodiments, the MMD from each of the plurality of data source modalities has at least two spatial dimensions (e.g., latitude 202 and longitude 204 dimensions) and one data modality dimension 206 which can include a plurality of data modalities as shown in FIG. 2. In some embodiments, the MMD from each of the plurality of data source modalities has three spatial dimensions (e.g., latitude, longitude, and depth/altitude dimensions) and one data modality dimension which can include a plurality of data modalities. In some embodiments, the spatial data 102 or mappable data 104 used includes derivative data generated, extrapolated or otherwise derived from any of the data described herein.

The MMD 102 and 104 is sampled, tokenized, and/or otherwise pre-processed prior to being processed by the one or more feature extractions networks 106. The geospatial information (e.g., geophysics, geology, geochemistry) is modeled using a multi-band georeferenced raster framework. A raster is a representation of a two dimensional plane as a matrix of n pixels organized into a rectangular grid of r rows and c columns where each pixel contains information. A georeferenced raster typically encodes geospatial information with a projection of the raster onto the Earth's surface using an Earth coordinate reference system. Therefore, every pixel on a georeferenced raster has a corresponding area on Earth's surface. The multi-band georeferenced raster framework described herein contains m rasters that represent geospatial information. A multi-band georeferenced raster is denoted as X={x₁, . . . , Xₙ} where xᵢ∈R^{m×1}. Here, the multi-band raster X∈R^{m×n}, or equivalently in raster format, X∈R^{m×r×c}.

Specifically, given a set of m explanatory feature layers, each layer is pre-processed each using a series of operations for ML MPM. First, each explanatory feature layer j={1, . . . ,m} is rasterized and georeferenced. Next, pixels xᵢ that were outliers or had missing values are removed or imputed, respectively. Tukey fences, which calculate lower and upper bounds (or fences) using the Interquartile Range (IQR) of the data, are used to remove outliers, while inverse distance weighting on surrounding pixel values followed by smoothing were used for imputation. Last, the m rasters are normalized to standard scores and geospatially aligned, for producing a multi-band georeferenced raster X∈R^{m×r×c}. After the above preprocessing, the multi-band raster X can be indexed with square windows of size w to produce samples for training. A sample x′∈R^{m×w×w} from X represents a 3D tensor, two dimensions for spatial extents (i.e., w×w) and one for the explanatory feature layers m as shown in FIG. 2.

In some embodiments, the one or more feature extraction networks 106 uses masked image modeling within a multi-band georeferenced raster framework to pretrain a deep learning model, that serves as the backbone for feature extraction in downstream MPM tasks. This inventive approach used self-supervised learning (SSL). SSL is a machine learning approach where models learn representations from unlabeled data by leveraging various implicit relationships. Common SSL methods include Contrastive Learning, Masked Modeling, Predictive Coding, and Cross-Modal Learning. Contrastive Learning learns by maximizing similarity between augmented views of the same instance while minimizing similarity between different instances. Masked Modeling instead predicts masked or missing portions of input data as the self-supervised task. In a similar vein, Predictive Coding, often use in time-series data, predicts future or contextual features from provided inputs. Cross-Modal Learning aligns relationships across modalities for paired data, such as images and text.

In some embodiments, the approach uses a type of self-supervised learning via masked image modeling. In masked image modeling, a visual deep neural network is pretrained by reconstructing input images that have severe signal loss (i.e., ˜75% input image pixels discarded). In the context of MPM, the input images correspond to samples x′ of X, where the spatial extents of x′ are image widths and heights of size w while the explanatory feature layers are image channels m. After pretraining, the backbone neural network is used for feature extraction in downstream MPM tasks.

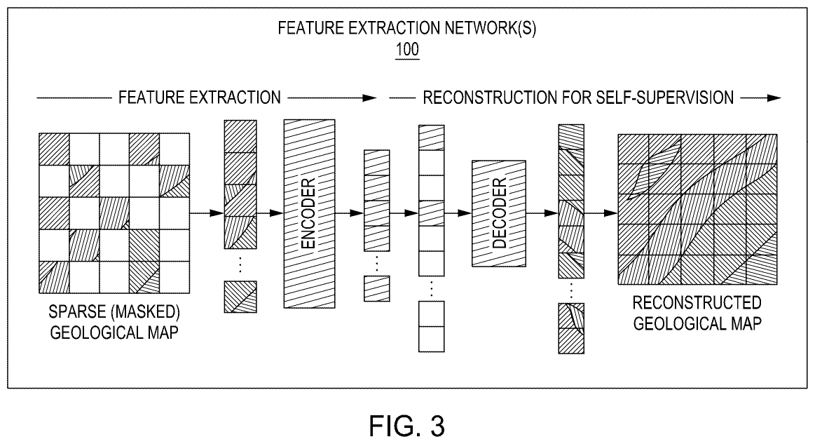

In some embodiments, the self-supervised model used by the one or more feature extraction networks 106 is an encoder-decoder architecture pretrained to reconstruct windows within a multi-band georeferenced raster x′ given their partial observations, see FIG. 3. First the input sample is divided into regular non-overlapping patches. A small minority of the patches are kept (i.e., ˜25%) while the remainder are masked. The unmasked patches are sequenced and processed into unmasked patch tokens by an encoder E, which in the architecture is a Vision Transformer. Next, the unmasked patch tokens are supplemented with mask tokens that indicate which patches of the sample x′ were masked. These mask tokens are a learned representation indicating missing values that need to be predicted. The sequence of both unmasked patch tokens and mask tokens are then processed by the decoder, a second shorter series of transformer blocks. The output of the decoder is a sequence of patches that are stitched back together to reconstruct the input image. The Mean Squared Error (MSE) between reconstructed image from the decoder x∧′ and the original input sample x′ is then the reconstruction objective used for pretraining, shown in Equation 1.

$$ℒ ss ( {x}_{i} ) = \frac{1}{m \times w \times w} {\sum }_{j} {( {x}_{i}^{′} - {\hat{x}}_{i}^{′} )}^{2} \qquad ( 1 )$$

Due to the asymmetric encoder-decoder design of this masked image modeling technique], the decoder has much fewer parameters and modeling capacity than the encoder. Therefore, the encoder E is optimized to learn a robust latent representation that summarizes the complete set of image patches when only a small portion of unmasked patches are observed. The learned features are a generic representation of the localized geospatial information that can be used for MPM. The encoder E alone can be used as the backbone network for feature extraction after pretraining.

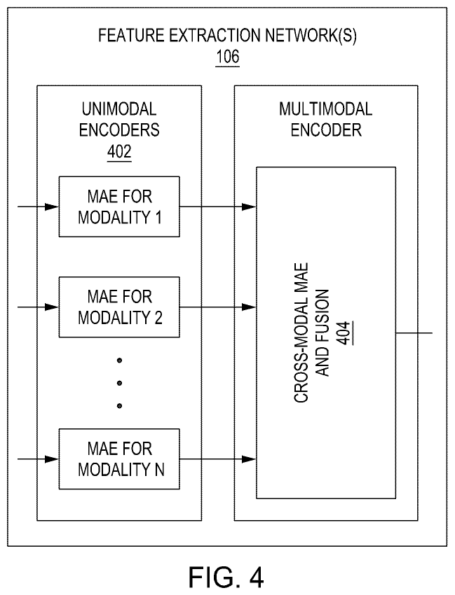

In some embodiments, the one or more feature extraction networks 106 includes one or more masked autoencoders (MAE) 402 and/or a multimodal masked autoencoder (MMAE) 404 as shown in FIG. 4. In some embodiments, other types of autoencorders may be used including variable auto-encoders (VAE), ones that add noise or other augmentation methods, image rotation, etc.

In some embodiments, the one or more feature extraction networks 106 are pre-trained by one or more MAEs 402 using self-supervised learning methods to extract features that are discriminative for reconstructing original data with partial or missing data. In some embodiments, each one of the plurality of data source modalities is associated with a corresponding one of the plurality of feature extraction networks to perform the feature extraction.

The one or more MAEs 402 are scalable, robust feature extractors for computer vision. The MAEs 402 can be used to pre-train feature extraction networks (such as vision transformers) using self-supervised learning, by masking (i.e., dropping) most of the input data signal. It trains the network to use the extracted features to reconstruct the complete, original observation/data. The self-supervised pre-training of MAEs enables the pretraining of unimodal and cross-modal encoders for MPM with no labels. Both encoders (e.g., feature extraction networks) can be fine-tuned using available labeled data, as other supervised learning methods. This technique will leverage all unlabeled and labeled data generated by the spatial data 102 and mappable criteria data 104.

In some embodiments, the features extracted from the MMD are fused using a multimodal masked encoder 404 (also referred to as a cross-modal encoder) to produce fused multimodal features. The multimodal masked encoder 404 further captures relationships among the different data source modalities.

After the features are fused by the one or more feature extraction networks 106, they are projected and stored into an embedding space 112. The embedding space 112 is trained to classify the feature's mineral deposit potential and used to obtain relationships among mineral types. A feature's mineral deposit potential is a probability and/or uncertainty as to the existence of a mineral at a geolocation. This probability can be a zero probability or 100% probability, or anything in between. In some embodiments, the embedding space 112 can be one or more of a Euclidian embedding space, semantic embedding space, or a hyperbolic embedding space.

The section describes at least one embodiment of the embedding space 112 used with the MPM system 100. Specifically, as noted above, MPM is considered an imbalanced, positive-unlabeled binary classification problem. A new undersampling method is provided for MPM by treating the samples that exclude those with exploration targets present as unlabeled data rather than negatives as described below. This new DL MPM approach combines the encoder E of the self-supervised network described above with a small classifier to form the function F associated with an embedding space 112 that estimates prospectivity. Described below are some embodiments of how F is trained to output prospectivity. It is then explained how feature attributions are used to compute which input features most influenced each prediction.

Positive-Unlabeled Learning. Prior MPM work assumes absence (i.e., negative samples x′_{neg}) for all remaining locations after excluding those with historical record of the exploration target being present (i.e., positive samples x′ₚₒₛ). Typically, dataset balancing process then takes the form of some combination of random undersampling the majority class, x′_{neg}, and random or synthetic oversampling the minority class, x′ₚₒₛ. However, this assumption (negative samples are the difference between the set of all samples and positive samples) increases the risks in labeling unknown true positives as negatives, i.e., X/x′ₚₒₛ≠x′_{neg}. Instead samples with unknown labels are introduced, X/x′ₚₒₛ=x′ᵤₙₖ, and a new undersampling approach is described to reduce this risk.

The approach reduces the chance of labeling unknown true positives as negatives, by taking into account the feature similarities between positive x′ₚₒₛ and unknown x′ᵤₙₖ samples. First, features for every sample in the MPM dataset are extracted. Sample features can be extracted directly from the m explanatory feature layers of the multi-band georeferenced raster. The encoder E is used to perform feature extraction. Specifically, the generic latent representation output from the encoder is used to process each sample x′ from X. The features for all samples x′ are then split into positive and unknown sample features according to X/x′ₚₒₛ=x′ᵤₙₖ. Then, these features are mapped/projected into an embedding space (e.g., embedding space 112) and a distance metric (e.g., Euclidean) is used to compute the similarity between each unknown sample x′ᵤₙₖ and all available positive samples x′ₚₒₛ. These distance computations result in a scale of unknown samples ordered by their similarity to the set of positive samples.

Finally, random undersampling is performed for samples that fall within a range on the computed positive similarity scale, which is treated as a hyperparameter. Empirically, it was found that filtering 5-10% of unknown samples most similar to the positive samples from undersampling to be effective.

Estimating Prospectivity. As noted above, MPM is treated as a binary classification problem in which estimates as to the likelihood for the presence of some mineral exploration target at discrete locations is sought. In the multi-band georeferenced raster framework used, discrete locations correspond to individual pixels xi within the multi-band raster X.

The encoder(s) E in the embodiments described above are used with small classifiers to form the architecture F that predicts prospectivity. For practical use of the MPM approach described herein in mineral commodity assessments, prospectivity is interpreted as providing both a presence likelihood and its uncertainty.

Discrete locations within the multi-band georeferenced raster framework are individual pixels xi∈{x₁, . . . , xn} within the multiband raster X. Samples x′i for each pixel are formed from indexing square windows of size w around xi. These samples, x′i∈R^{m×w×w}, are 3D tensors that represent the local geospatial information, such as geophysical measurements, for xi. Each xi is also accompanied by a label yi indicating whether the mineral exploration target is present, absent, or unknown. Note yi is a label for the center pixel within x′. The presence labels are determined by indexing the raster grid according to historical records of observed mineral deposits. In embodiments consistent with the present disclosure, the absent and unknown labels are determined by undersampling method described above.

For each exploration target, the encoder E described in embodiments herein is paired with a small classifier to form the architecture that is trained with labeled samples. The combined architecture forms the function F, described in embodiments here, that estimates prospectivity. The function F is trained on the subset of samples labeled either present or absent; unknown samples are used to make continuous prospectivity maps and excluded in training. The classifier in the embedding space 112 consists of a Multi-Layer Perceptron (MLP) with parametric rectified linear units for activation layers and BatchNorms for normalization layers. As input, the classifier processes the single-dimensional latent features extracted by the encoder E. The classifier associated with embedding space 112 outputs a single scalar y∧ᵢ estimating the presence likelihood at xᵢ, y∧ᵢ=F(x′ᵢ)=p(yᵢ=present|x′ᵢ). A Binary Cross-Entropy (BCE) is used between the predictions y∧ᵢ and labels yᵢ as the supervised training objective Ls, shown in Equation 2 where j indexes only samples labeled as present or absent and J is the number of such samples.

$$ℒ s ( {\hat{y}}_{i} , {y}_{i} ) = - \frac{1}{J} {\sum }_{j} {y}_{i} \cdot log ( {\hat{y}}_{i} ) + ( 1 - {y}_{i} ) \cdot log ( 1 - {\hat{y}}_{i} ) \qquad ( 2 )$$

This method provides model uncertainty associated with each prediction using Monte-Carlo (MC) Dropout. Epistemic uncertainty is often overlooked in prior ML MPM implementations, although uncertainties are inherently present within the MPM problem. Epistemic uncertainty is the reducible portion of a model's total predictive uncertainty, due to a lack of sufficient knowledge. Many sources of epistemic uncertainty exist, including insufficient data, low diversity of training examples, and others. MC Dropout is used to provide the epistemic uncertainty within the MPM predictions associated with the learned parameters of F. To implement MC Dropout, the MLP classifier contains Dropout within each layer. The Dropouts are kept active both at training and inference time to estimate the mean and variance of the predictive distribution, the presence likelihood. The mean and variance of the presence likelihood are estimated using the sample mean and variance over T stochastic forward passes of the classifier.

In the above embodiments, a Euclidian embedding space 112 was trained and used to determine a mineral's deposit potential and relationships between the mineral types. In some embodiments, a hyperbolic embedding space may be used to determine a mineral's deposit potential and relationships between the mineral types. Specifically, by leveraging hyperbolic spaces, hierarchical relations, class likelihoods, and uncertainties of all multimodal embeddings can be represented and which are used to generate detailed mineral potential data including, but not limited to, high-resolution mineral potential maps.

In some embodiments, a Poincaré ball model of hyperbolic space may be used. The Poincare ball model ( [symbol] ⁿ, g [symbol] ) is defined by the manifold [symbol] ⁿ={x∈ [symbol] ⁿ: ∥x∥<1} endowed with the Riemannian metric g [symbol] (x)=λ×g^{E}, where

$${λ}_{x} = \frac{2}{1 - {‖ x ‖}^{2}}$$

is the conformal factor and g^{E}=Iⁿ. Note, hyperbolic spaces are not vector spaces; to be able to perform neural network operations like addition, a Gyrovector space formalism should be used. The Gyrovector space is a generalization of Euclidean vector spaces to models of hyperbolic space based on Mobius transformations. As a result, corresponding vector space operations can be performed, which are required in traditional Euclidean embedding space for neural network operations, using Möbius transformations.

The hyperbolic space are used to encode embedding classification likelihood, uncertainty, and mineral hierarchical relations that prevent model overfitting. Classification likelihood is proportional to the hyperbolic distance of an embedding to a gyroplane representing the class. Classification uncertainty is measured as the l² norm to the origin in the Poincare ball. By directly extracting classification uncertainties from the hyperbolic embeddings the MPM system circumvents expensive sampling and computations necessary for Bayesian techniques (e.g., BCNN or Dropout), while achieving comparable uncertainty estimations. Hierarchical relationships can be represented using hyperbolic distances between embeddings.

The MPM system 100 further includes a mineral potential data module 120 configured to generate mineral deposit potential data. In some embodiments, the mineral deposit potential data generated may include one or more of a mineral potential map depicting a spatial output of mineral deposit potential and/or other data structures such as a graph of the data, a 2D or 3D representation of the data, a text description of the data, and the like. The feature's mineral deposit potential is a probability and/or uncertainty as to the existence of a mineral at a geolocation. In some embodiments, the mineral potential data generated may include probability data 122 and/or uncertainty data 124 (e.g., a probability map and/or uncertainty map). In some embodiments, probability and uncertainty may be displayed in the same set of data or on the same map.

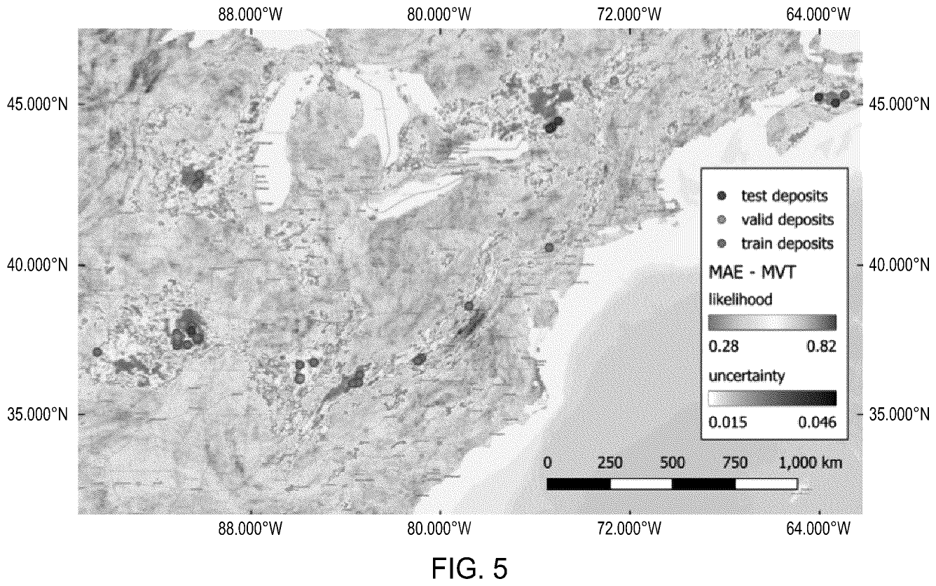

Specifically, using the formulations and information discussed above produced in association with embedding space 112, embodiments consistent with this DL MPM approach outputs one or more georeferenced rasters (i.e., mineral potential maps). For example, in some embodiments, the maps produced may represent the prospectivity mean (i.e., probability shown in FIG. 5) and standard deviation (i.e., uncertainty shown as standard deviation in FIG. 5). The trained classifier is used to compute the mean and variance of the exploration target presence likelihood for every sample x′i. By reverse-indexing the samples x′i to their corresponding pixels xi within the multi-band georeferenced raster X, continuous maps of the presence likelihood mean and standard deviation can be generated. FIG. 5 shows the eastern United States MVT Lead-Zinc prospectivity maps generated by the map generation module 120. The mean prospectivity map 122 is visualized as a heatmap (red color as highest value), while the standard deviation is shown on the map in gray-scale (black color as highest value).

In some embodiments, the MPM system 100 further includes an importance score and feedback module 130 that is configured to calculate an importance score for every feature depicted in the mineral potential data generated (e.g., on the mineral potential map) to show which input features contribute most to the prediction made in the mineral potential data generated. In some embodiments, the importance score and feedback module 130 may be used in Integrated Gradient approach to calculating the importance scores, which is an explainable AI technique that attributes an importance value to each input feature of a machine learning model based on the gradients of the model output with respect to the input.

In some embodiments, the importance score and feedback module 130 further uses/processes physics and expert domain knowledge feedback on the importance scores and predictions made on the mineral potential data to retrain or adjust the weighting of at least one of the feature extraction networks, embedding space, the mineral potential data as shown in FIG. 1.

Explaining DL MPM Predictions (e.g., Explainable AI). It is important for domain experts to interpret and verify the predictions from DL methods. However, validation of DL generated prospectivity data/maps from a geological perspective is challenging due to the complex nature of these techniques. Prior ML MPM work have been limited to providing aggregate explanatory variable importance over many predictions. Variable importance on every input feature for individual predictions can better help validate individual predictions spatially, in addition to relative importances between explanatory variables in the aggregate. As the domain knowledge about mineralization continues to evolve, being able to assess explanatory variable importance spatially could provide new insights from which correlations get highlighted.

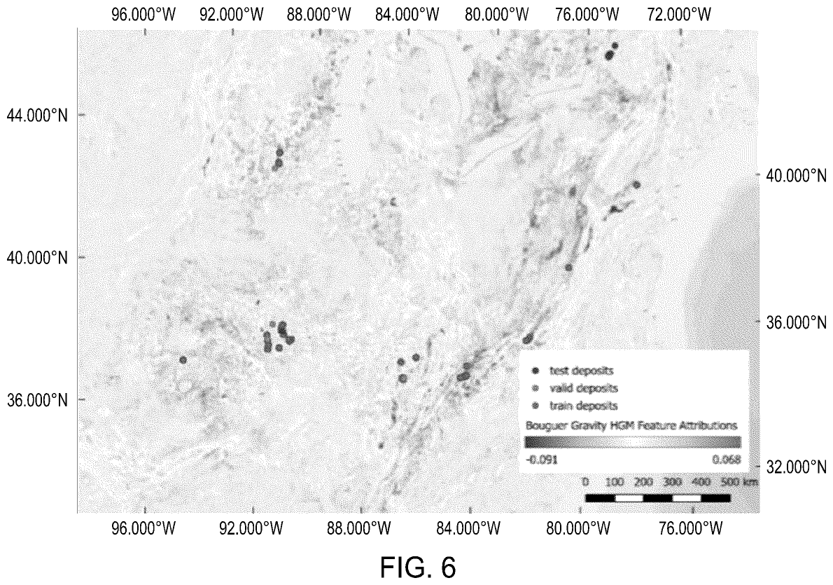

As introduced above, in some embodiments, explainable artificial intelligence technique, Integrated Gradients (IG), is optionally used to compute importance scores for every input feature to a DL MPM prediction. IG is a method used to compute which input features contribute most to the prediction made by the DL model, thus improving the interpretability. For an input sample x′, the gradient of the network with respect to x′ is computed along a path from a baseline sample to x′. The integral of these gradients provides the importance score for each feature. The baseline sample has the same dimensionality as x′ but serves as a reference devoid of any input signal (i.e., a zero-tensor). Similar to prospectivity, the samples x′i can be reverse-indexed to their corresponding pixels xi within the multi-band georeferenced raster X, for generating continuous maps of feature importance for all m explanatory feature layers. In FIG. 6, the feature importance map is shown for an explanatory variable as a heatmap (green color as the high value). The signs and magnitudes of IG importance scores indicate the type of association and strength of contribution, respectively, the input has on the prediction. Positive IG values increase the presence likelihood while negative values decrease it.

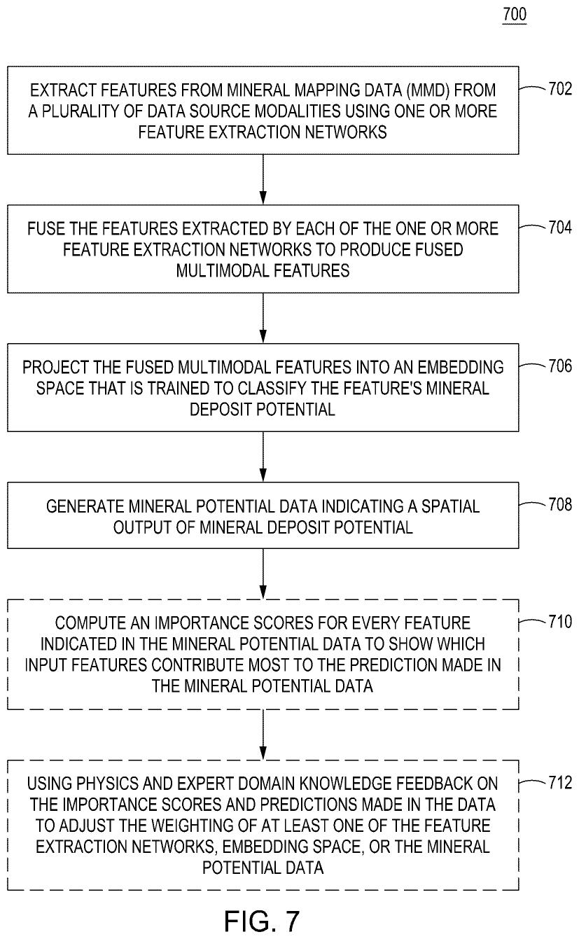

FIG. 7 depicts a flow chart of a Mineral Prospectivity Mapping (MPM) method 700 for generating mineral potential data consistent with the embodiments described above with respect to FIGS. 1-6. The method begins at 702 where features from mineral mapping data (MMD) are extracted from a plurality of data source modalities using one or more feature extraction networks 106. In some embodiments, the MMD 102 and 104 is sampled, tokenized, and/or otherwise pre-processed prior to being processed at 702 by the one or more feature extractions networks 106.

At 704, the features extracted by each of the one or more feature extraction networks are fused to produce fused multimodal features. In some embodiments, the one or more feature extraction networks 106 use masked image modeling within a multi-band georeferenced raster framework to pretrain a deep learning model, that serves as the backbone for feature extraction in downstream MPM tasks. In some embodiments, the one or more feature extraction networks 106 are pre-trained by one or more masked autoencoders (MAE) using self-supervised learning methods to extract features that are discriminative for reconstructing original data with partial or missing data.

At 706, the fused multimodal features are projected, and/or stored, into an embedding space that is trained to classify the feature's mineral deposit potential. As discussed above, the embedding space is used to obtain relationships among mineral types, and can be one or more of a Euclidian embedding space, semantic embedding space, or a hyperbolic embedding space.

At 708, mineral potential data is generated indicating a spatial output of mineral deposit potential, wherein the feature's mineral deposit potential is a probability and/or uncertainty as to the existence of a mineral at a geolocation. The data can be generated by the mineral potential data generation module 120 as described above.

At 710, importance scores are computed for every feature depicted in the mineral potential data to show which input features contribute most to the prediction made in the mineral potential data. As discussed above, this may be computed using an integrated gradient approach, and may be performed by the importance score and feedback module 130.

At 712, physics and expert domain knowledge feedback may be used based on the importance scores and predictions made in the data generated to adjust the weighting of at least one of the feature extraction networks, embedding space, or the mineral potential data.

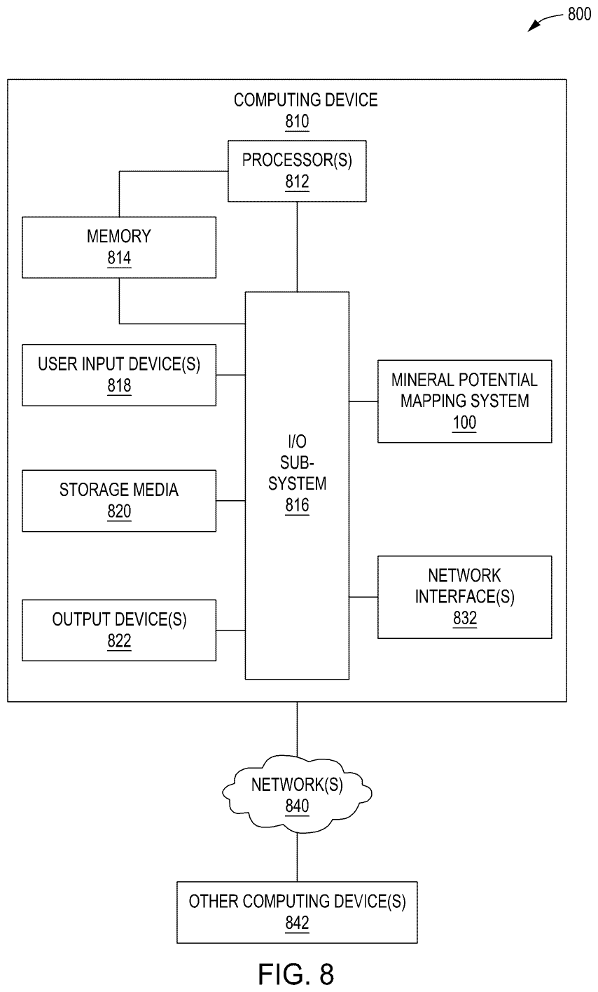

Referring now to FIG. 8, a simplified block diagram of an exemplary computing environment 800 for the MPM system 100. The illustrative implementation 800 includes a computing device 810, which may be in communication with one or more other computing systems or devices 842 via one or more networks 840. In some embodiments, portions of the MPM system 100 may be incorporated into other systems or interactive software applications or work with such systems or applications. Such applications or systems may include, for example, operating systems, middleware or framework (e.g., application programming interface or API) software, and/or user-level applications software (e.g., a search engine, a virtual personal assistant, a messaging application, a web browser, another interactive software application or a user interface for a computing device).

The illustrative computing device 810 includes at least one processor 812 (e.g. a microprocessor, microcontroller, digital signal processor, etc.), memory 814, and an input/output (I/O) subsystem 816. The computing device 810 may be embodied as any type of computing device such as a personal computer (e.g., a desktop, laptop, tablet, smart phone, wearable or body-mounted device, etc.), a server, an enterprise computer system, a network of computers, a combination of computers and other electronic devices, or other electronic devices. Although not specifically shown, it should be understood that the I/O subsystem 816 typically includes, among other things, an I/O controller, a memory controller, and one or more I/O ports. The processor 812 and the I/O subsystem 816 are communicatively coupled to the memory 814. The memory 814 may be embodied as any type of suitable computer memory device (e.g., volatile memory such as various forms of random access memory).

The I/O subsystem 816 is communicatively coupled to a number of components including one or more user input devices 818, one or more storage media 820, one or more output devices 822 (e.g., display screens, speakers, LEDs, etc.), the MPM system 100, and one or more network interfaces 832.

The storage media 820 may include one or more hard drives or other suitable data storage devices (e.g., flash memory, memory cards, memory sticks, and/or others). In some embodiments, portions of systems software (e.g., an operating system, etc.), framework/middleware (e.g., APIs, object libraries, etc.), reside at least temporarily in the storage media 820.

The one or more network interfaces 832 may communicatively couple the computing device 810 to a network, such as a local area network, wide area network, personal cloud, enterprise cloud, public cloud, and/or the Internet, for example. Accordingly, the network interfaces 832 may include one or more wired or wireless network interface cards or adapters, for example, as may be needed pursuant to the specifications and/or design of the particular computing system 800. The network interface(s) 832 may provide short-range wireless or optical communication capabilities using, e.g., Near Field Communication (NFC), wireless fidelity (Wi-Fi), radio frequency identification (RFID), infrared (IR), or other suitable technology.

The other computing system(s) 842 may be embodied as any suitable type of computing system or device such as any of the aforementioned types of devices or other electronic devices or systems. The computing system 800 may include other components, sub-components, and devices not illustrated in FIG. 8 for clarity of the description. In general, the components of the computing system 800 are communicatively coupled as shown in FIG. 8 by electronic signal paths, which may be embodied as any type of wired or wireless signal paths capable of facilitating communication between the respective devices and components.

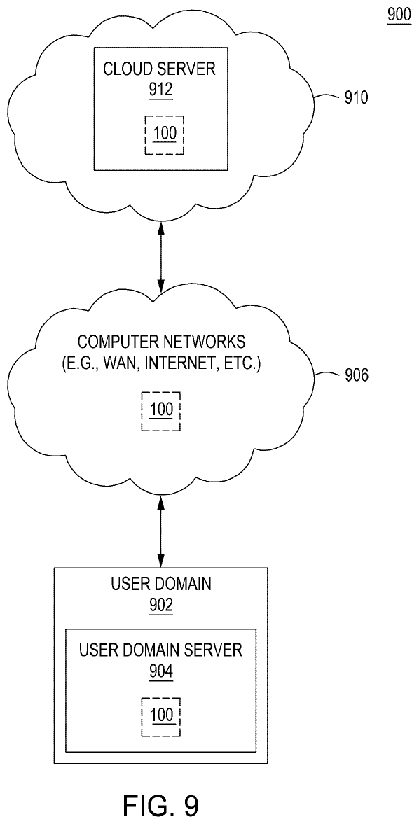

FIG. 9 depicts a high level block diagram of a network in which embodiments of a Mineral Prospectivity Mapping (MPM) system 100 for generating mineral potential data in accordance with the present principles can be applied. The network environment 900 of FIG. 9 illustratively comprises a user domain 902 including a user domain server 904. The network environment 900 of FIG. 9 further comprises computer networks 906, and a cloud environment 910 including a cloud server 912.

In the network environment 900 of FIG. 9, a mineral potential mapping system in accordance with the present principles, such as the MPM system 100 of FIG. 1, can be included in at least one of the user domain server 904, the computer networks 906 and the cloud server 912. That is, in some embodiments, a user or automated process can use a local server (e.g., the user domain server 904) to provide spatial data and/or mappable criteria that can be used by the MPM system 100 in accordance with the present principles and on which mineral potential data generation is to be performed.

In some embodiments, a user can implement a MPM system 100 in the computer networks 906 to provide images/data that can be used generated mineral potential data in accordance with the present principles. Alternatively or in addition, in some embodiments, a user can implement a MPM system 100 in the cloud server 912 of the cloud environment 910 to provide images/data that can be used generated mineral potential data in accordance with the present principles. For example, in some embodiments it can be advantageous to perform processing functions of the present principles in the cloud environment 910 to take advantage of the processing capabilities of the cloud environment 910. In some embodiments in accordance with the present principles, an MPM system can be located in a single or multiple locations/servers/computers to perform all or portions of the herein described functionalities of the MPM system 100 in accordance with the present principles.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine (e.g., a computing device or a “virtual machine” running on one or more computing devices). For example, a machine-readable medium may include any suitable form of volatile or non-volatile memory.

Modules, data structures, and the like defined herein are defined as such for ease of discussion, and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure.

The foregoing methods and embodiments thereof have been provided in sufficient detail but it is not the intention of the applicant(s) for the disclosed system and embodiments provided herein to be limiting. Additional adaptations and/or modifications are possible, and, in broader aspects, these adaptations and/or modifications are also encompassed. Accordingly, departures may be made from the foregoing system and embodiments without departing from the spirit of the system.

This disclosure is to be considered as exemplary and not restrictive in character, and all changes and modifications that come within the guidelines of the disclosure are desired to be protected.

1. A Mineral Prospectivity Mapping (MPM) method of generating mineral potential data, comprising:
extracting features from mineral mapping data (MMD) from a plurality of data source modalities using one or more feature extraction networks;
fusing the features extracted by each of the one or more feature extraction networks to produce fused multimodal features;
projecting the fused multimodal features into an embedding space that is trained to classify the features' mineral deposit potential; and
generating mineral deposit potential data indicating a spatial output of mineral deposit potential.

2. The method of claim 1, wherein the one or more feature extraction networks are pre-trained using a self-supervised learning method to extract features that are discriminative for reconstructing original data with partial or missing data.

3. The method of claim 2, wherein each one of the plurality of data source modalities is associated with a corresponding one of the plurality of feature extraction networks to perform the feature extraction.

4. The method of claim 1, wherein the features extracted are fused using a self-supervised learning method to capture relationships among the different data source modalities.

5. The method of claim 1, wherein the one or more feature extraction networks are used to both extract and fuse the features from the MMD.

6. The method of claim 1, wherein the embedding space is used to obtain relationships among mineral types.

7. The method of claim 1, wherein the embedding space is a multidimensional embedding space.

8. The method of claim 1, wherein the features' mineral deposit potential is a probability and/or uncertainty as to the existence of a mineral at a geolocation.

9. The method of claim 1, wherein the mineral mapping data includes labeled and unlabeled data.

10. The method of claim 1, wherein the mineral mapping data includes spatial data and/or mappable criteria.

11. The method of claim 10, wherein the spatial data includes one or more of geophysics data, geological maps, remote sensing data, or geochemistry data, and wherein the mappable criteria includes one or more of a location of mineral deposit sites, grading models, or tonnage models.

12. The method of claim 1, wherein the MMD from each of the plurality of data source modalities has at least two spatial dimensions and one data modality dimension.

13. The method of claim 1, further comprising computing importance scores for every feature included in the mineral potential data to show which input features contribute most to the prediction made in the mineral potential data.

14. The method of claim 13, using physics and expert domain knowledge feedback on the importance scores and predictions made in the mineral potential data to retrain or to adjust the weighting of at least one of the feature extraction networks, embedding space, or the mineral potential data.

15. The method of claim 1, wherein the data generated is a graphical mineral potential map depicting the spatial output of mineral deposit potential.

16. A Mineral Prospectivity Mapping (MPM) system for generating mineral potential data, comprising:
one or more feature extraction networks configured to:
extract features from mineral mapping data (MMD) obtained from a plurality of data source modalities; and
fuse the features extracted by each of the one or more feature extraction networks to produce fused multimodal features;
an embedding space configured to store the fused multimodal features projected into it, and trained to classify the features' mineral deposit potential; and
a mineral potential data generation module configured to generate mineral potential data indicating a spatial output of mineral deposit potential.

17. The MPM system of claim 16, wherein the one or more feature extraction networks are pre-trained using a self-supervised learning method to extract features that are discriminative for reconstructing original data with partial or missing data.

18. The MPM system of claim 16, further comprising an importance score and feedback module configured to compute importance scores for every feature included in the mineral potential data to show which input features contribute most to the prediction made in the mineral potential data.

19. The MPM system of claim 18, wherein the importance score and feedback module is further configured to use physics and expert domain knowledge feedback on the importance scores and predictions made in the mineral potential data to retrain or to adjust the weighting of at least one of the feature extraction networks, embedding space, or the mineral potential data.

20. A non-transitory computer readable medium for storing computer instructions that, when executed by at least one processor causes the at least one processor to perform a method for generating mineral potential data, the method comprising:
extracting features from mineral mapping data (MMD) from a plurality of data source modalities using one or more feature extraction networks;
fusing the features extracted by each of the one or more feature extraction networks to produce fused multimodal features;
projecting the fused multimodal features into an embedding space that is trained to classify the features' mineral deposit potential; and
generating mineral deposit potential data indicating a spatial output of mineral deposit potential.
